(19) United States
(12) Patent Application Publication
(10) Pub. No.: US 2026/0263854 A1
(43) Pub. Date: Sep. 10, 2026

(54) ELECTRICALLY-STARTED NON-PRESSURIZED-STORAGE-TYPE LIQUID-BASED EXPLOSION SUPPRESSION CANNISTER

(71) Applicant: HUBEI INSTITUTE OF AEROSPACE CHEMICAL TECHNOLOGY, Xiangyang, Hubei (CN)

(72) Inventors: Peiwen Qin, Xiangyang, Hubei (CN); Hang Zhang, Xiangyang, Hubei (CN); Ruihua Lu, Xiangyang, Hubei (CN); Youran Zhu, Xiangyang, Hubei (CN); Changlong Huang, Xiangyang, Hubei (CN); Leilei Lu, Xiangyang, Hubei (CN); Lifan Yan, Xiangyang, Hubei (CN); Jiefan Zhang, Xiangyang, Hubei (CN)

(21) Appl. No.: 19/160,895

(22) PCT Filed: Jun. 15, 2023
(86) PCT No.: PCT/CN2023/100318

§ 371 Date: Aug. 29, 2025

(30) Foreign Application Priority Data
Mar. 1, 2023 (CN) 202310203487.2

(51) Int. Cl. A62C 35/02; A62C 37/36

(52) U.S. Cl. CPC A62C 35/023; A62C 37/04

(57) ABSTRACT

An electrically-started non-pressurized-storage-type liquid-based explosion suppression cannister is provided, which comprises: a cannister body, a liquid fire extinguishing agent, a fire extinguishing agent drive assembly, a primary rupture sheet, and a sputter nozzle; the cannister body and the primary rupture sheet at the bottom of the cannister body form a cannister; the fire extinguishing agent drive assembly is arranged at the inside of an opening of the cannister body, and is used for rupturing the primary rupture sheet, forming a liquid fire extinguishing agent initial outflow channel; the sputter nozzle is connected to the primary rupture sheet, and is used for atomizing and spraying the liquid fire extinguishing agent flowing out from the location of the primary rupture sheet; the fire extinguishing agent drive assembly comprises a securing member, an electric starter, a gas generation member, and an action member; and the electric starter comprises an electric ignition tube.

### TECHNICAL FIELD

The present disclosure generally relates to the field of firefighting technology, and in particular to an electrically-started non-pressurized-storage-type liquid-based explosion suppression cannister.

### BACKGROUND

Explosion suppression cannisters used in the field of firefighting technology mostly use a pressure storage solution of ultrafine dry powder. The cannister contains a mixture of ultrafine dry powder and high-pressure gas, which requires regular maintenance and inspection for pressure leaks. Ultrafine dry powder will disperse in the explosion suppression area during operation, and when used to extinguish fires in confined spaces such as airplanes or vehicles, it will affect the vision of passengers and drivers in the cabin. Ultrafine dry powder pressurized-storage-type explosion suppression cannisters use electric detonators to open the blasting disc, which will inevitably produce fragments, posing a potential hazard to the safety of people in the cabin.

### SUMMARY

An objective of the present disclosure lies in providing an electrically-started non-pressurized-storage-type liquid-based explosion suppression cannister that replaces the existing ultra-fine dry powder pressure storage with a non-pressure-storage liquid fire extinguishing agent. This non-pressure-storage solution with a positive-arch cross-groove bursting disc is utilized, resulting in no fragmentation and improved safety. The clean liquid fire extinguishing agent used does not pose a health risk to passengers.

The present disclosure provides an electrically-started non-pressurized-storage-type liquid-based explosion suppression cannister, including a cannister body, liquid fire extinguishing agent, a fire extinguishing agent actuation assembly, a primary rupture sheet, and a sputter nozzle. The cannister body and the primary rupture sheet provided at a bottom thereof constitute a cannister unit, and the cannister unit is configured to contain the liquid fire extinguishing agent and to place the fire extinguishing agent drive assembly. The fire extinguishing agent drive assembly is provided inside a mouth of the cannister body and is configured to destroy, through a driving force of its action, the primary rupture sheet to form an initial overflow channel for the liquid fire extinguishing agent. The sputter nozzle is connected to the primary rupture sheet, and is configured to atomize and spray the liquid fire extinguishing agent overflowing from the primary rupture sheet. The fire extinguishing agent drive assembly includes a securing member, an electric starter, a gas generation member and an action member; the securing member is configured to secure the fire extinguishing agent drive assembly on an inside of the mouth of the cannister body; the electric starter is configured to generate an electric starting signal and includes an electric squib (electric ignition tube), wherein the electric squib is configured to activate the fire extinguishing agent drive assembly; the gas generation member is configured to generate gas to drive the action member to move and pressurize the liquid fire extinguishing agent, and the gas generation member includes a gas generation agent; and the action member directly destroys the primary rupture sheet or forms a driving force to destroy the primary rupture sheet under an action of the gas generated by the gas generation agent.

Furthermore, the liquid fire extinguishing agent is one of 1, 1, 1, 2, 2, 4, 5, 5, 5-nonafluoro-4-(trifluoromethyl)-3-pentanone and 2-bromo-3, 3, 3,-trifluoropropene or a mixture of thereof, a loading amount of the liquid fire extinguishing agent accounts for 85-95% of a volume of the cannister unit, with a filling amount of 0.5-10 kg.

Furthermore, the securing member of the fire extinguishing agent drive assembly includes screws and a flange; and a central tube is provided inside the mouth of the cannister body; the flange secures the fire extinguishing agent drive assembly in the central tube by the screws, and a joint of the cannister body, the flange and the central tube is sealed by a sealing ring; the sealing ring is made of EPDM material; the electric starter is provided at a center of the flange; the electric starter further includes an electric squib base, a short-circuit ring, an electric squib sealing ring, an ignition powder box and an ignition powder; the electric squib base is configured to secure the electric squib, and the electric squib sealing ring is provided between an inner edge of the flange and an outer edge of the electric squib base to seal a connection between the flange and the electric squib base; the ignition powder box containing the ignition powder is sealed and connected below the electric squib base; a charge weight of the electric squib is 30 ~300 mg, and an activation current is not less than 1.0 A.

Furthermore, the ignition powder is one or more of black powder, a mixture of boron and potassium nitrate, and a polymer of magnesium and polytetrafluoroethylene, with a charge weight of 2 to 20 g.

Furthermore, the gas generation member further includes a combustion chamber, where the combustion chamber and a gas generation agent contained therein are provided in a space between a periphery of the ignition powder box and the central tube; and the gas generation agent is a composite solid propellant, where a combustion temperature of the gas generation agent does not exceed 1400 K; a burning rate is not less than 10 mm/s; a sum of the outer surface area of the charge, i.e., an initial burning area, is not less than 20,000mm²; a gas generation amount is 13 to 26 mol/kg, and a charge weight is 10 to 100 g.

Furthermore, the action member is provided below the combustion chamber and communicates with the combustion chamber through a through hole below the combustion chamber; the action member moves downward along an inner wall of the central tube under a pushing of the gas in the combustion chamber.

Furthermore, the action member includes a piston rod, a piston seal, and an anti-vibration spring. The piston rod is a T-shaped structure, with an upper horizontal rod connected to the combustion chamber, a lower vertical rod passing through the anti-vibration spring, and a bottom end 0.5-5 mm away from the primary rupture sheet. The piston sealing ring is provided on a periphery of the piston rod, and is configured to realize sealing between the piston rod and an inner wall of the center tube. The anti-vibration spring is provided at a lower part of the piston rod, and is configured to prevent the piston rod from being dislocated under a vibration environment, where a head of the piston rod is spherical.

Furthermore, the action member includes a piston, a piston seal, and an anti-vibration spring. The piston is an inverted U-shaped structure, with an upper portion connected to the combustion chamber and a lower portion connected to the anti-vibration spring. The piston sealing ring is provided on the periphery of the piston, and is configured to achieve sealing between the piston and the inner wall of the center tube. The anti-vibration spring is configured to prevent the piston rod from being dislocated in the vibrating environment.

Furthermore, a first pressure relief hole is provided on a tube wall of the central tube below the action member, and when the action member moves to a position below the first pressure relief hole, the first pressure relief hole, an escape channel for the gas generated by a combustion of the gas generation agent is formed to pressurize the liquid fire extinguishing agent in the cannister unit.

Furthermore, a plurality of rows of evenly distributed second pressure relief holes are provided on the sidewalls of the combustion chamber, and the second pressure relief holes are configured to allow a portion of gas generated by the combustion of the gas generation agent to escape between the central tube and the action member, and when the action member moves to a position below the first pressure relief hole, they pressurize the liquid fire extinguishing agent in the cannister unit.

Furthermore, the action member includes a piston, a piston seal, a vibration damping spring, a jet tube, a bursting disc pressure cap, and a side bursting disc. The side bursting disc, the bursting disc pressure cap, the piston, and the anti-vibration spring are sequentially provided below the combustion chamber in the central tube, and provided below the combustion chamber, and the jet tube is connected to a bottom of the central tube. The side bursting disc is provided on a sidewall of the central tube, and an opening pressure of the side bursting disc is greater than an opening pressure of the primary rupture sheet; and the piston is of an H-shaped structure, and two sides thereof are sealed and connected to an inside of the central tube.

Furthermore, the side bursting disc is a positive arched bursting disc with a groove, and the groove is a cross-shaped groove with an opening pressure of 1-10 MPa.

Furthermore, the primary rupture sheet is a positive arched, grooved bursting disc, the groove is a cross-shaped groove, a diameter thereof is at least 40 mm, and the opening pressure of the primary rupture sheet is 0.2-2 MPa.

Furthermore, the electrically-started non-pressurized-storage-type liquid-based explosion suppression cannister further includes a fixed base, where the fixed base is configured to secure the cannister unit, and comprises a U-shaped bolt, a flange nut and a base support; and the U-shaped bolt is secured to the base support via the flange nut, and an arc shape of the base support and the U-shaped bolt form a ring shape consistent with a shape of a top, a middle or a bottom of the cannister unit, so as to surround and secure the top, the bottom or the middle of the cannister unit; and a conical surface is provided in the sputter nozzle to atomize and spray the fire extinguishing agent.

Furthermore, the gas generation agent is a composite solid propellant, and the gas generation agent includes a binder, a curing agent, an oxidizing agent, and a cooling agent; the binder includes hydroxyl-terminated polybutadiene and/or carboxyl-terminated polybutadiene, with a content of 10% to 40% by mass; the curing agent is toluene diisocyanate and/or isophorone diisocyanate, with a content of 0.5% to 5% by mass; the oxidizing agent is ammonium perchlorate and/or ammonium nitrate, with a content of 20% to 60% by mass; and the cooling agent is azodicarbonamide, with a content of 20% to 60% by mass.

The present disclosure is superior to the prior art in the following aspects.
1) In the prior art, the fire extinguishing medium of stored-pressure halon explosion suppression cannisters for armored vehicles is gaseous halon, and the cannister is pre-filled with 4.2 MPa nitrogen. This exhibits a slow decompression phenomenon similar to conventional stored-pressure fire extinguishers, requiring regular leak detection. Furthermore, the detonation wave generated by an electric detonator is required to open the bursting disc and release the fire extinguishing agent. Due to a tearing effect of the detonation wave, fragments are inevitably generated, posing a risk of injury. The present disclosure uses a thrust generated by the gas generation agent to drive the piston rod or piston to exert thrust on the bursting disc, thereby destroying the bursting disc. This does not generate fragments, significantly reducing the risk.
2) The present disclosure utilizes the combustion of the gas generation agent to generate gas, which serves as both the driving force for the action member and the pressurization driving force for the liquid fire extinguishing agent. Furthermore, a heating effect of the gas generated by the combustion of the gas generation agent provides conditions for subsequent atomization. This solves the problems of high flow resistance, high heat capacity, and difficulty in atomizing liquid media at low temperatures in the prior art. The liquid fire extinguishing agent is pressurized within the cannister unit by the combustion gas of the gas generation agent and is ejected at high pressure through the sputter nozzle, achieving excellent atomization. Even at low temperatures, it can be pressurized to achieve the desired atomization effect and explosion suppression effectiveness.
3) The fire extinguishing agent drive assembly of the present disclosure has an integrated design of an electric starter, a gas generation member, and an action member. By using a traditional electric squib in the electric starter in combination with a certain amount of ignition powder (an additional ignition powder box and a specific type and dosage of ignition powder are provided), and by coordination between the gas generation agent, the combustion chamber, and the action member, the explosion suppression cannister can spray fire extinguishing agent within 3 ms when an electric start signal is given, and can spray more than 3 kg of fire extinguishing medium within 110 ms. Its start time is faster than 7 ms or more in the prior art.
4) This disclosure ensures a speed and volume of gas production through the design of burning rate of the gas generation agent, initial combustion area, and charge weight. The design of action member and pressure relief hole pressurizes the liquid fire extinguishing agent to a predetermined range while the main blasting disc fragment is shattered. This allows for the atomization and dispersion of at least 3 kg of fire extinguishing agent into a designated area within an extremely short time (50 ms), achieving rapid fire extinguishing and explosion suppression. Furthermore, the use of a liquid clean fire extinguishing agent instead of traditional ultrafine dry powder eliminates the issues of ultrafine dry powder impairing a vision of the driver after dispersed and affecting breathing of the passengers after breathed.
4) This disclosure utilizes a non-pressure storage design and a positive arch cross-groove blasting disc, eliminating fragmentation. The non-pressure storage solution solves the problem of the risk of injury from fragments after the bursting disc is opened in the traditional pressure storage solution. At the same time, the non-pressure storage solution has no high pressure in the cannister when not working, which is safer and does not require regular maintenance.
5) The device of the present disclosure features a simple structure and principle, employing a non-pressure storage design. This involves generating gas through the operation of a gas generation member, generating high pressure within the cannister unit in a very short period of time. Once the opening pressure of the primary rupture sheet is reached, the liquid fire extinguishing agent inside is rapidly ejected under the pushing of the high-pressure gas, which can achieve the effect of extinguishing the fire and suppressing the explosion.
6) The device structure of the present disclosure has the characteristics of adapting to a wide range of ambient temperatures. The gas generated by the gas generation agent heats and pressurizes the liquid fire extinguishing agent. In combination with a special type of liquid fire extinguishing agent, the device of the present disclosure can work normally in a wide temperature range and can achieve the characteristic of a wide operating temperature range, that is, the ambient temperature can be from −50° C. to +80° C.

The working process of the invented device is that the electrical signal activates the gas generation agent in the combustion chamber, the gas generation agent is activated within 0.5 ms, generating a large amount of high-pressure gas, which pushes the action component below to move, and the primary rupture sheet at the bottom of the cannister unit is opened; subsequently, the liquid fire extinguishing agent inside is rapidly ejected under the pushing of the high-pressure gas generated by the generator, and upon striking the sputter nozzle located at the bottom of the cannister unit, it is rapidly atomized and dispersed into a designated area, thereby achieving the purpose of suppressing the explosion and extinguishing the fire.

### BRIEF DESCRIPTION OF DRAWINGS

These and/or other aspects and advantages of the present disclosure will become more apparent and easier to understand from the following detailed description of the embodiments of the present disclosure, taken in combination with the drawings, wherein:

FIG. 1 is a structural schematic diagram of an electrically-started non-pressurized-storage-type liquid-based explosion suppression cannister in Embodiment 1 of the present disclosure;

FIG. 2 is a structural schematic diagram of a fire extinguishing agent drive assembly in in Embodiment 1 of the present disclosure;

FIG. 3 is a structural schematic diagram of an electrically-started non-pressurized-storage-type liquid-based explosion suppression cannister in Embodiment 2 of the present disclosure;

FIG. 4 is a structural schematic diagram of a fire extinguishing agent drive assembly in in Embodiment 2 of the present disclosure;

FIG. 5 is a structural schematic diagram of an electrically-started non-pressurized-storage-type liquid-based explosion suppression cannister in Embodiment 3 of the present disclosure;

FIG. 6 is a structural schematic diagram of a fire extinguishing agent drive assembly in in Embodiment 3 of the present disclosure;

FIG. 7 is a structural schematic diagram of a fixed base in the electrically-started non-pressurized-storage-type liquid-based explosion suppression cannister in Embodiment of the present disclosure;

FIG. 8 is a graph of an operating pressure at the outlet of a bottom of the electrically-started non-pressurized-storage-type liquid-based explosion suppression cannister in Embodiment 1 of the present disclosure;

FIG. 9 is a graph showing an initial operating pressure inside the electrically-started non-pressurized-storage-type liquid-based explosion suppression cannister in Embodiment 2 of the present disclosure; and

FIG. 10 is a graph showing the operating pressure at the outlet of the bottom of the electrically-started non-pressurized-storage-type liquid-based explosion suppression cannister in Embodiment 2 of the present disclosure.

Where: 1—cannister unit, 2—liquid fire extinguishing agent, 3—fire extinguishing agent drive assembly, 4—primary rupture sheet, 5—sputter nozzle, 6—fixed base, 301—flange, 302—squib base, 303—short—circuit ring, 304—squib tube, 305—electric squib sealing ring, 306—center tube, 307—piston rod, 307-1—piston, 308—piston sealing ring, 309—vibration—proof spring, 310—combustion chamber, 311—gas generation agent, 312—ignition powder box, 313—ignition powder; 61—U-type bolt, 62—flange nut, 63—base support, 314—jet tube, 315—bursting disc pressure cap, 316—side bursting disc; 61—U-type bolt, 62—flange nut, 63—base support.

### DETAILED DESCRIPTION OF EMBODIMENTS

To facilitate a better understanding of the present disclosure by those skilled in the art, the present disclosure is further described below in combination with the drawings and specific embodiments.

### Embodiment 1

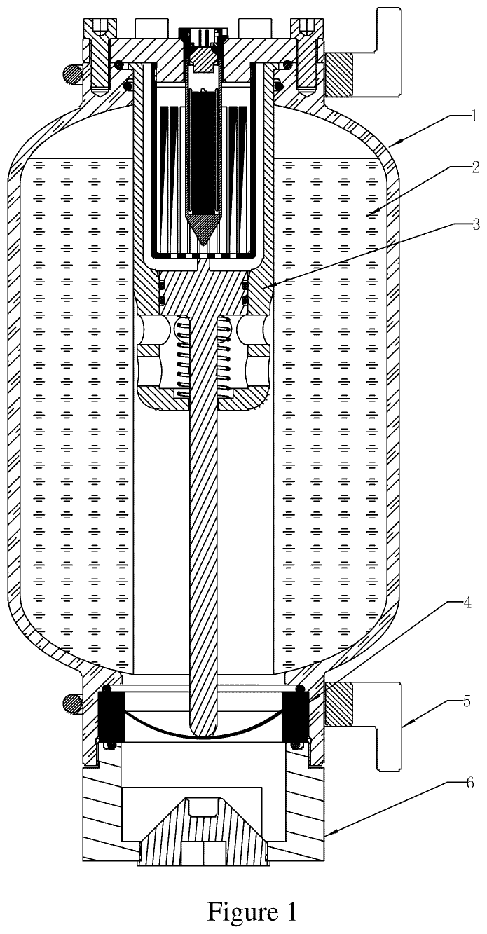

An electrically-started non-pressurized-storage-type liquid-based explosion suppression cannister, as shown in FIG. 1, includes a cannister body 1, liquid fire extinguishing agent 2, a fire extinguishing agent drive assembly 3, a primary rupture sheet 4, a sputter nozzle 5, and a fixed base 6.

The functions and interconnections of each of the parts are described as follows.

The cannister body 1 and the primary rupture sheet 4 provided at a bottom thereof constitute a cannister unit, wherein the cannister unit is configured to contain the liquid fire extinguishing agent 2 and place the fire extinguishing agent drive assembly 3.

The fire extinguishing agent drive assembly 3 is provided inside a mouth of the cannister body 1 and is configured to destroy the primary rupture sheet 4 through a driving force of an action of the fire extinguishing agent drive assembly to form an initial overflow channel for the liquid fire extinguishing agent 2.

The sputter nozzle 5 is connected to the primary rupture sheet 4 and is configured to atomize and spray the liquid fire extinguishing agent 2 that overflows from the primary rupture sheet 4.

The fixed base 6 is configured to secure the cannister unit.

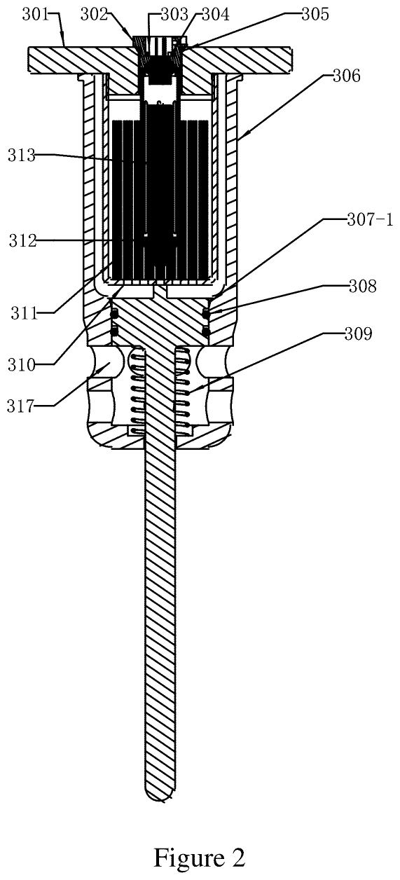

A core of the device lies in the fire extinguishing agent drive assembly 3. The fire extinguishing agent drive assembly 3 includes a securing member, an electric starter, a gas generation member, and an action member. The securing member is configured to fix the fire extinguishing agent drive assembly 3 to an inside of the mouth of the cannister body 1. The electric starter is configured to generate an electric starting signal and includes an electric squib 304, wherein the electric squib 304 is configured to activate the fire extinguishing agent drive assembly 3. The gas generation member is configured to generate gas to drive the action member to move and pressurize the liquid fire extinguishing agent 2. The gas generation member includes a gas generation agent 311. The action member directly destroys the primary rupture sheet 4 or generates a driving force to destroy the primary rupture sheet 4 under an action of the gas generated by the gas generation agent 311. The specific structure of the action member is shown in FIG. 2.

The action member is provided below the combustion chamber 310 and is communicated to the combustion chamber 312 through a through hole below the combustion chamber 312. The action member moves downward along an inner wall of a central tube 306 under a pushing of the gas in the combustion chamber 312, and the specific structure of the action member includes a piston rod 307, a piston sealing ring 308 and an anti-vibration spring 309. The piston rod 307 is a T-shaped structure, an upper cross bar is connected to the combustion chamber 312, and a lower vertical bar passes through the anti-vibration spring 309 and a bottom end is 3-4 mm away from the primary rupture sheet 4. The piston sealing ring 308 is provided on a periphery of the piston rod 307, and is configured to realize sealing between the piston rod 307 and an inner wall of the central tube 306. The anti-vibration spring 309 is provided at a lower part of the piston rod 307, and is configured to prevent the piston rod 307 from being dislocated under a vibration environment. A head of the piston rod is spherical. A first pressure relief hole 317 is provided on a tube wall of the central tube 306 below the action member. When the action member moves below the first pressure relief hole 317, the first pressure relief hole 317 forms an escape channel for the gas generated by a combustion of the gas generation agent 311, thereby pressurizing the liquid fire extinguishing agent 2 within the cannister unit. The sidewalls of the combustion chamber 310 are provided with multiple rows of evenly distributed second pressure relief holes. These second pressure relief holes are configured to allow the gas generated by the combustion of the gas generation agent 311 to escape between the central tube 306 and the action member. When the action member moves below the first pressure relief hole 317, they pressurize the liquid fire extinguishing agent 2 within the cannister unit.

The other parts of the fire extinguishing agent drive assembly 3 are as follows.

The securing member includes screws and a flange 301. The flange 301 secures the fire extinguishing agent drive assembly 3 to the center tube 306 inside the mouth of the cannister body 1 by screws, and a joint between the cannister body 1, flange 301, and center tube 306 forms a seal.

The electric starter is provided at the center of the flange 301. The electric starter further includes an electric squib base 302, a short-circuit ring 303, an electric squib seal ring 305, and an ignition powder box 312 and ignition powder 313. The electric squib base 302 is configured to secure the electric squib 304. The electric squib seal ring 305 is provided between an inner edge of the flange 301 and an outer edge of the electric squib base 302 to seal a connection between the flange 301 and the electric squib base 302. The ignition powder box 312 containing the ignition powder 313 is sealed and connected to an underside of the electric squib base 302. A charge weight of the electric squib 304 is 45-60 mg, and an activation current is no less than 1.0 A.

The ignition powder 313 is one or more of black powder, a mixture of boron and potassium nitrate, and a magnesium and polytetrafluoroethylene polymer, with a charge of 6-10 g. The screws are eight M8 hexagon socket head cap screws.

The gas generation member further includes a combustion chamber 310. The combustion chamber 310 and the gas generation agent 311 contained therein are provided in a space between a periphery of the ignition powder box 312 and the central tube 306. The gas generation agent is a composite solid propellant including a binder, a curing agent, an oxidizing agent, and a cooling agent. The binder includes hydroxyl-terminated polybutadiene and/or carboxyl-terminated polybutadiene, with a content of 10% to 40% by mass. The curing agent includes toluene diisocyanate and/or isophorone diisocyanate, with a content of 0.5% to 5% by mass. The oxidizing agent includes ammonium perchlorate and/or ammonium nitrate, with a content of 20% to 60% by mass. The cooling agent includes azodicarbonamide, with a content of 20% to 60% by mass.

The composite solid propellant has a combustion temperature not exceeding 1400K, a burning rate not less than 34 mm/s, a charge weight of 30-100 g, a sum of an outer surface area of the charge, i.e., an initial combustion area not less than 50,000 mm², a gas generation volume of 13 to 26 mol/kg, and a charge weight of 30-50 g.

Other specific designs include as follows.

The liquid fire extinguishing agent 2 is one of 1, 1, 1, 2, 2, 4, 5, 5, 5-nonafluoro-4-trifluoromethyl-3-pentanone and 2-bromo-3, 3, 3-trifluoropropene, or a mixture thereof. A loading amount of the liquid fire extinguishing agent 2 accounts for 85-95% of a volume of the cannister unit, and the filling amount is 4-10 kg.

The primary rupture sheet 4 is a positive-arched, grooved bursting disc. The groove is a cross-shaped groove with a diameter of 65 mm. The opening pressure is 0.5-2 MPa.

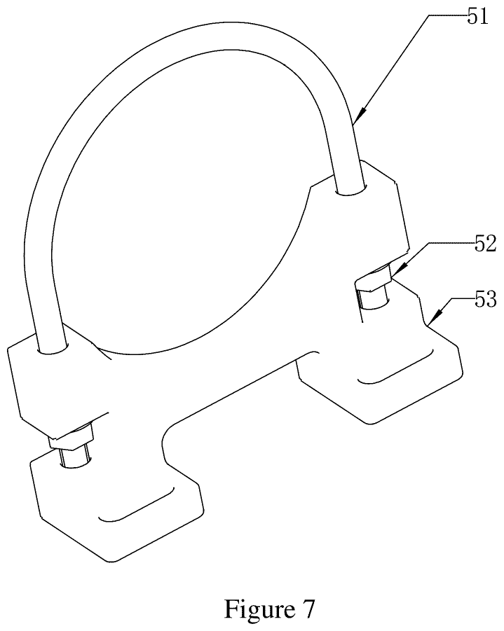

The structure of the fixing base 6 is shown in FIG. 7. The fixing base 6 includes a U-shaped bolt 61, a flange nut 62, and a base support 63. The U-shaped bolt 61 is secured to the base support 63 via the flange nut 62. The arc shape of the base support 63 and the U-shaped bolt 61 form a ring shape that conforms to the bottom shape of the cannister unit 1, thereby surrounding and securing the bottom of the cannister unit 1.

The sputter nozzle 5 is internally provided with a conical surface to rapidly atomize and spray the fire extinguishing agent.

The operating process of this electrically-started non-pressurized-storage-type liquid-based explosion suppression cannister is as follows. An electrical signal activates a gas generation member in the electric squib 304. The gas generation member activates within 2 milliseconds, generating a large amount of high-pressure gas. This pushes the piston rod located below to move, and the primary rupture sheet at the bottom of the cannister unit is opened. As the piston rod 307 moves downward and passes through the first pressure relief hole at the bottom of the central tube, the seal between the piston rod 307 and the central tube fails. Gas generated by the gas generation agent inside the central tube is ejected through the first pressure relief hole, simultaneously pressurizing the liquid fire extinguishing agent within the cannister unit. Subsequently, the liquid fire extinguishing agent inside is rapidly ejected under the pushing of the high-pressure gas generated by the generator. Upon striking the sputter nozzle located at the bottom of the cannister unit, the liquid fire extinguishing agent is rapidly atomized and dispersed into a designated area, thereby achieving the purpose of suppressing the explosion and extinguishing the fire.

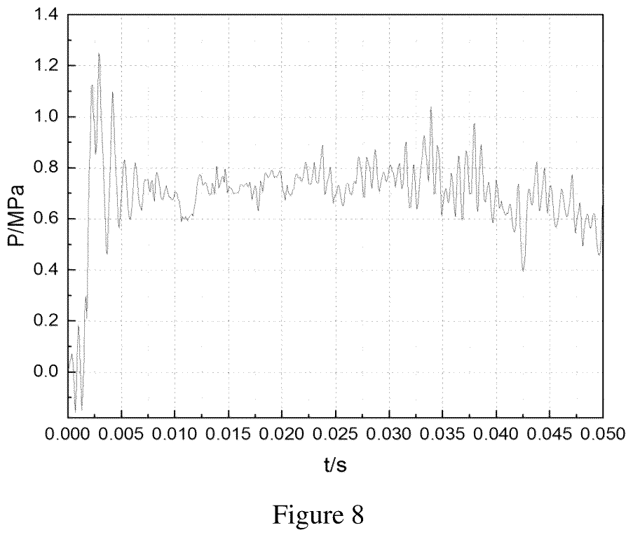

FIG. 8 shows a graph of an operating pressure at the outlet of the bottom of the electrically-started non-pressurized-storage-type liquid-based explosion suppression cannister of this embodiment. Here, a pressure sensor is located directly below the bottom outlet outside the cannister unit and outside the bursting disc, directly in contact with the atmosphere. When the pressure is significantly higher than atmospheric pressure, it indicates that fire extinguishing agent is being ejected, representing an activation time of the explosion suppression cannister. As can be seen from the figure, the activation time (from input of an activation time signal to the ejection of the fire extinguishing agent) is 1.5 ms, which is significantly ahead of the current industry competitors (5~7 ms).

### Embodiment 2

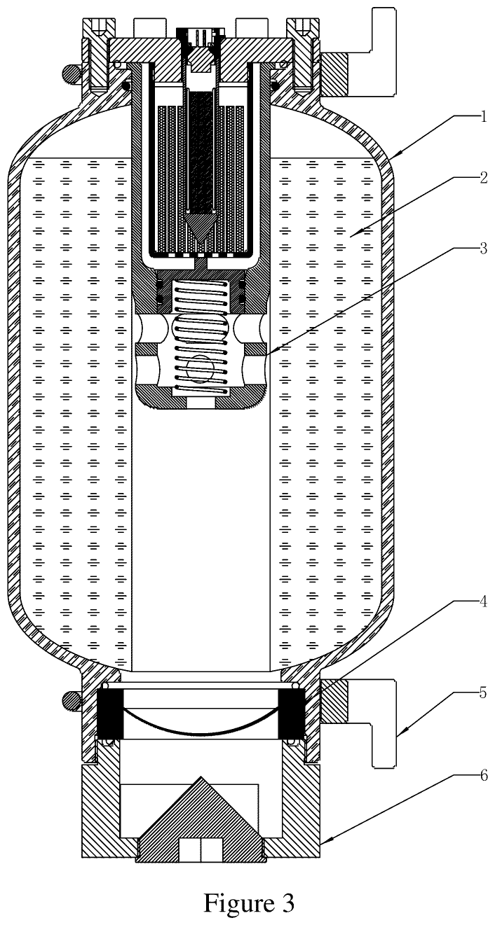

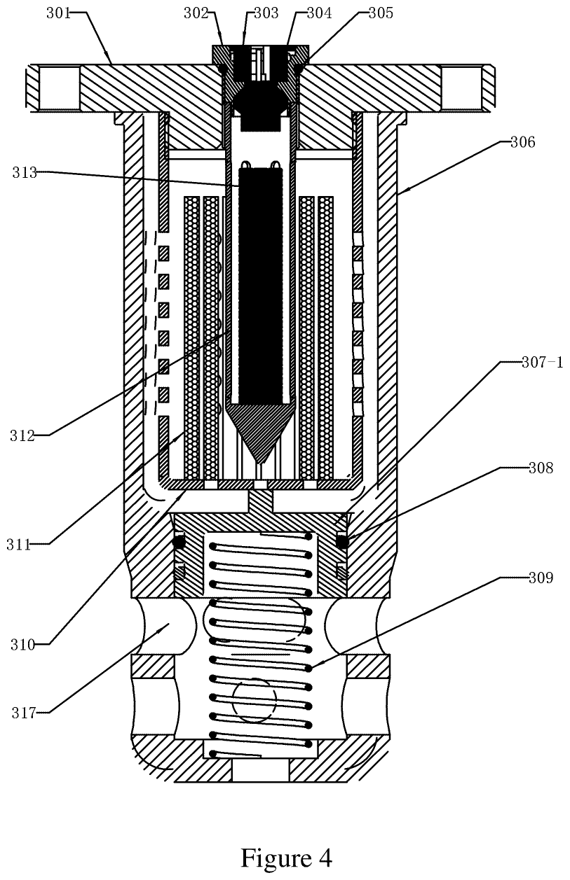

An electrically-started non-pressurized-storage-type liquid-based explosion suppression cannister is provided, and the structure of which is shown in FIG. 3. The difference from the structure of the embodiment lies in the action member in the fire extinguishing agent drive assembly 3. The structure of the fire extinguishing agent drive assembly 3 and its action member is shown in FIG. 4. It can be seen that its action member includes a piston 307-1, a piston sealing ring 308 and an anti-vibration spring 309. The piston 307-1 is an inverted U-shaped structure, the upper portion of which is connected to the combustion chamber 312, and the lower portion is connected to the anti-vibration spring 309. The piston sealing ring 308 is provided on the periphery of the piston 307-1, and is configured to achieve sealing between the piston rod 307 and the inner wall of the center tube 306. The anti-vibration spring 309 is configured to prevent the piston rod (307) from being dislocated under a vibration environment.

As in Embodiment 1, a first pressure relief hole 317 is provided on the tube wall of the central tube 306 below the action member. When the action member moves below the first pressure relief hole 317, the first pressure relief hole 317 forms an escape channel for the gas generated by the combustion of the gas generation agent 311, thereby pressurizing the liquid fire extinguishing agent 2 in the cannister unit. A plurality of rows of evenly distributed second pressure relief holes are provided in the sidewalls of the combustion chamber 310. These second pressure relief holes are configured to allow the gas generated by the combustion of the gas generation agent 311 to escape between the central tube 306 and the action member. When the action member moves below the first pressure relief hole 317, they pressurize the liquid fire extinguishing agent 2 in the cannister unit.

The operating process of this electrically-started non-pressurized-storage-type liquid-based explosion suppression cannister is as follows. An electrical signal activates the gas generation member, which activates within 2 milliseconds, generating a large amount of high-pressure gas. This pushes the piston below it to move. The piston in turn pushes the liquid fire extinguishing agent below, and the primary rupture sheet at the bottom of the cannister unit is opened. The liquid fire extinguishing agent inside is then rapidly ejected under the pushing of the high-pressure gas generated by the generator. Upon striking the sputter nozzle located at the bottom of the cannister unit, the liquid fire extinguishing agent rapidly be atomized and dispersed into a designated area, thereby achieving the purpose of suppressing the explosion and extinguishing the fire.

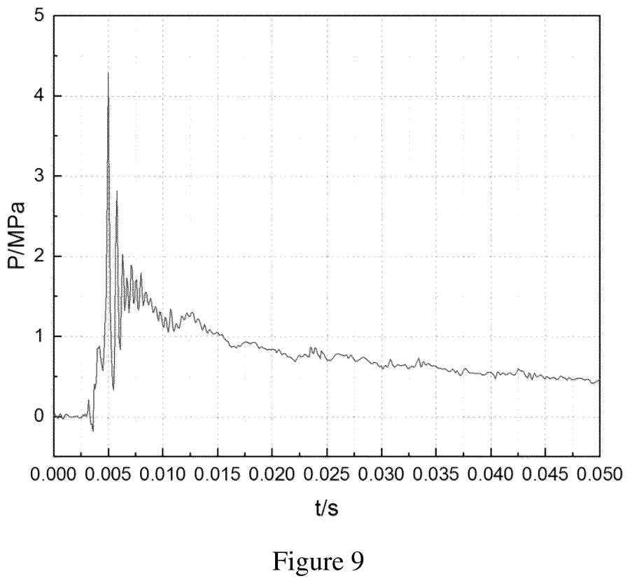

FIG. 9 shows a graph of the operating pressure at the outlet of the bottom of the electrically-started non-pressurized-storage-type liquid-based explosion suppression cannister of this embodiment. Here, the pressure sensor is located directly below the bottom outlet outside the cannister unit and outside the bursting disc, directly in contact with the atmosphere. When the pressure is significantly higher than atmospheric pressure, it indicates that fire extinguishing agent is being ejected, representing the activation time of the explosion suppression cannister. As shown in the figure, the activation time (from input of an activation time signal to the ejection of the fire extinguishing agent) is 2.5 ms, which is significantly ahead of the current industry competitors (5~7 ms).

### Embodiment 3

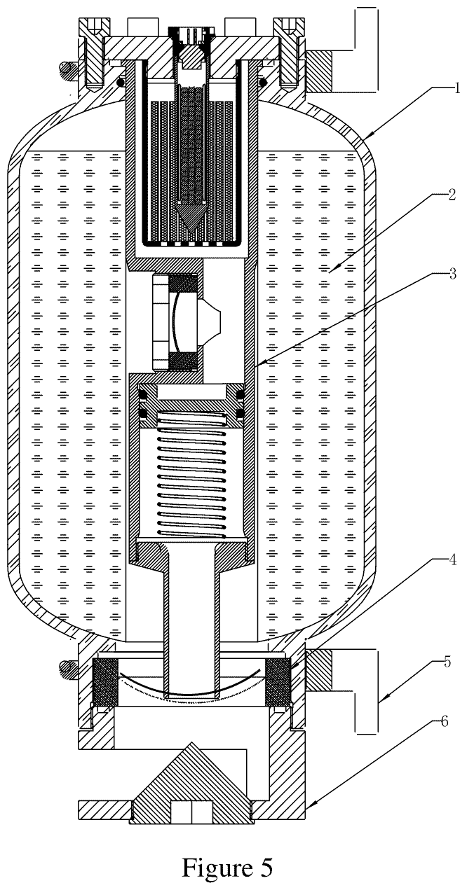

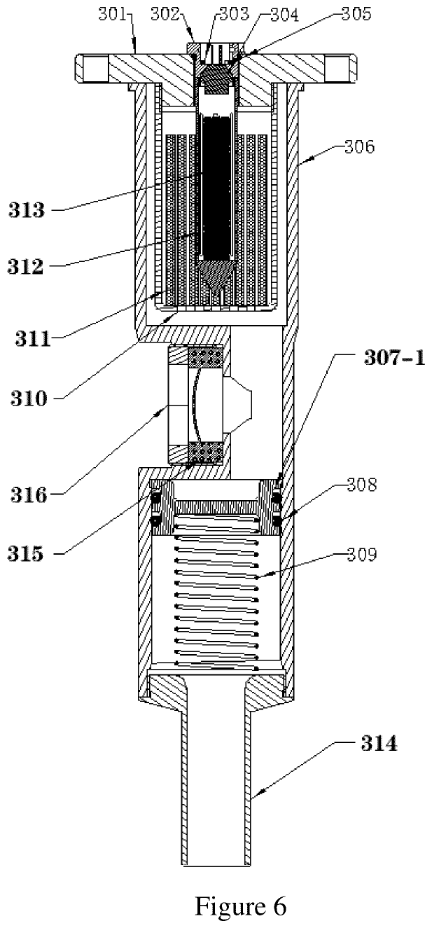

An electrically-started non-pressurized-storage-type liquid-based explosion suppression cannister is provided, and the structure of which is shown in FIG. 5. The difference from the structure of the embodiments lies in the fire extinguishing agent drive assembly 3 and its action members. The structure of the fire extinguishing agent drive assembly 3 is shown in FIG. 6. It can be seen that the action member 11 in the electrically-started non-pressurized-storage-type liquid-based explosion suppression cannister as described in claim 6 is characterized in that the action member includes a piston 307-1, a piston sealing ring 308, a vibration-damping spring 309, a jet tube 314, a bursting disc pressure cap 315, and a side bursting disc 316. The side bursting disc 316, the bursting disc pressure cap 315, piston 307-1, and vibration damping spring 309 are sequentially provided below the combustion chamber within the central tube 306. Provided below the combustion chamber 310, the jet tube 314 is connected to the bottom of the central tube 306. The side bursting disc 316 is provided on a sidewall of the central tube 306, and an opening pressure of the side bursting disc is greater than that of the primary rupture sheet 316. The piston 307-1 is H-shaped structure, with both sides sealed and connected to the inside of the central tube 306.

Preferably, the side bursting disc 316 is a positive-arched, grooved bursting disc. The groove is a cross-shaped groove with an opening pressure of 5-10 MPa. This means that its opening pressure is greater than that of the primary rupture sheet 4. After the primary rupture sheet 4 is ruptured, the high pressure generated by the combustion of the gas generation agent further opens the side bursting disc 316, allowing gas to enter the cannister unit and be pressurized.

The working process of this embodiment is as follows. An electrical signal activates the gas generation member. The gas generation member activates within 2 ms, generating a large amount of high-pressure gas. This pushes the piston 307-1 located below it to move. The piston 307-1 squeezes the liquid fire extinguishing agent inside the center tube 306 and the jet tube 314 (compared to Embodiments 1 and 2, the jet tube 314 and its interior are not sealed with the fire extinguishing agent in this embodiment; the liquid fire extinguishing agent fully fills the jet tube 314 before activation). This creates a hydraulic device that ejects the liquid fire extinguishing agent at high speed. The primary rupture sheet at the bottom of the cannister unit is opened under the squeezing of the high-speed liquid fire extinguishing agent. When the pressure in the center tube 306 reaches the opening pressure of the side bursting disc 316, the side bursting disc 316 is opened, allowing gas generated by the gas generation agent to enter into the cannister unit, rapidly increasing the pressure inside the cannister. The fire extinguishing agent in the cannister is ejected under the pushing of the high-pressure gas. Upon striking the sputter nozzle located at the bottom of the cannister unit, the liquid fire extinguishing agent is rapidly atomized and dispersed into a designated area, thereby achieving the purpose of suppressing the explosion and extinguishing the fire.

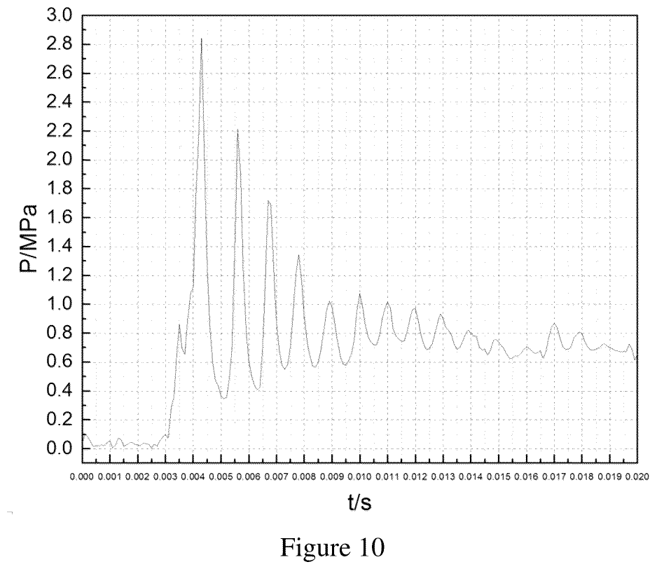

FIG. 10 shows a graph of the operating pressure at the outlet of the bottom of the electrically-started non-pressurized-storage-type liquid-based explosion suppression cannister of this embodiment. The pressure sensor is located directly below the bottom outlet outside the cannister unit. A rise in pressure indicates the ejecting of fire extinguishing agent, so the first inflection point of the pressure curve represents the activation time of the explosion suppression cannister. As shown in the graph, the activation time (rom input of an activation time signal to the ejection of the fire extinguishing agent) is 3 ms, which is significantly ahead of the current industry competitors (5~7 ms).

While various embodiments of the present disclosure have been described above, the foregoing description is intended to be illustrative, non-exhaustive, and not limiting of the disclosed embodiments. Numerous modifications and variations will be apparent to those ordinarily skilled in the art without departing from the scope and spirit of the described embodiments. Therefore, the scope of the present disclosure shall be determined by the scope of the claims.

1. An electrically-started non-pressurized-storage-type liquid-based explosion suppression cannister, comprising a cannister body, a liquid fire extinguishing agent a fire extinguishing agent drive assembly, a primary rupture sheet and a sputter nozzle;
the cannister body and the primary rupture sheet provided at a bottom thereof constitute a cannister unit, and the cannister unit is configured to contain the liquid fire extinguishing agent and to place the fire extinguishing agent drive assembly;
the fire extinguishing agent drive assembly is provided inside a mouth of the cannister body, and is configured to destroy, through a driving force of its action, the primary rupture sheet to form an initial overflow channel for the liquid fire extinguishing agent;
the sputter nozzle is connected to the primary rupture sheet, and is configured to atomize and spray the liquid fire extinguishing agent overflowing from the primary rupture sheet; and
the fire extinguishing agent drive assembly comprises a securing member, an electric starter, a gas generation member and an action member; the securing member is configured to secure the fire extinguishing agent drive assembly on an inside of the mouth of the cannister body; the electric starter is configured to generate an electric starting signal and comprises an electric squib, wherein the electric squib is configured to activate the fire extinguishing agent drive assembly; the gas generation member is configured to generate gas to drive the action member to move and pressurize the liquid fire extinguishing agent, and the gas generation member comprises a gas generation agent; and the action member directly destroys the primary rupture sheet or forms a driving force to destroy the primary rupture sheet under an action of the gas generated by the gas generation agent.

2. The electrically-started non-pressurized-storage-type liquid-based explosion suppression cannister according to claim 1, wherein the liquid fire extinguishing agent is one of 1, 1, 1, 2, 2, 4, 5, 5, 5-nonafluoro-4-(trifluoromethyl)-3-pentanone and 2-bromo-3, 3, 3,-trifluoropropene or a mixture of thereof, a loading amount of the liquid fire extinguishing agent accounts for 85-95% of a volume of the cannister unit, with a filling amount of 0.5-10 kg.

3. The electrically-started non-pressurized-storage-type liquid-based explosion suppression cannister according to claim 1, wherein
the securing member of the fire extinguishing agent drive assembly comprises screws and a flange; and a central tube is provided inside the mouth of the cannister body;
the flange secures the fire extinguishing agent drive assembly in the central tube by the screws, and a joint of the cannister body, the flange and the central tube is sealed by a sealing ring; and the sealing ring is made of EPDM material;
the electric starter is provided at a center of the flange; and the electric starter further comprises an electric squib base, a short-circuit ring, an electric squib sealing ring, an ignition powder box and an ignition powder;
the electric squib base is configured to secure the electric squib, and the electric squib sealing ring is provided between an inner edge of the flange and an outer edge of the electric squib base to seal a connection between the flange and the electric squib base;
the ignition powder box containing the ignition powder is sealed and connected below the electric squib base;
a charge weight of the electric squib is 30~300 mg, and an activation current is not less than 1.0 A.

4. The electrically-started non-pressurized-storage-type liquid-based explosion suppression cannister according to claim 3, wherein
the ignition powder is one or more of black powder, a mixture of boron and potassium nitrate, and a polymer of magnesium and polytetrafluoroethylene, with a charge weight of 2 to 20 g.

5. The electrically-started non-pressurized-storage-type liquid-based explosion suppression cannister according to claim 1, wherein
the gas generation member further comprises a combustion chamber, wherein the combustion chamber and a gas generation agent contained therein are provided in a space between a periphery of the ignition powder box and the central tube; and
the gas generation agent is a composite solid propellant, wherein a combustion temperature does not exceed 1400 K; a burning rate is not less than 10 mm/s; a sum of the outer surface area of the charge, i.e., an initial burning area, is not less than 20,000 mm²; a gas generation amount is 13 to 26 mol/kg, and a charge weight is 10 to 100 g.

6. The electrically-started non-pressurized-storage-type liquid-based
explosion suppression cannister according to claim 5, wherein the action member is provided below the combustion chamber and communicates with the combustion chamber through a through hole below the combustion chamber; and the action member moves downward along an inner wall of the central tube under a pushing of gas in the combustion chamber.

7. The electrically-started non-pressurized-storage-type liquid-based explosion suppression cannister according to claim 6, wherein the action member comprises a piston rod, a piston sealing ring and an anti-vibration spring;
the piston rod is a T-shaped structure, with an upper horizontal rod connected to the combustion chamber, a lower vertical rod passing through the anti-vibration spring, and a bottom end 0.5-5 mm away from the primary rupture sheet;
the piston sealing ring is provided on a periphery of the piston rod, and is configured to realize sealing between the piston rod and an inner wall of the center tube;
the anti-vibration spring is provided at a lower part of the piston rod, and is configured to prevent the piston rod from being dislocated under a vibration environment, wherein
a head of the piston rod is spherical.

8. The electrically-started non-pressurized-storage-type liquid-based explosion suppression cannister according to claim 6, wherein the action member comprises a piston, a piston sealing ring, and an anti-vibration spring;
the piston is an inverted U-shaped structure, with an upper portion connected to the combustion chamber and a lower portion connected to the anti-vibration spring;
the piston sealing ring is provided on the periphery of the piston, and is configured to achieve sealing between the piston and the inner wall of the center tube; and
the anti-vibration spring is configured to prevent the piston rod from being dislocated in the vibrating environment.

9. The electrically-started non-pressurized-storage-type liquid-based explosion suppression cannister according to claim 7, wherein a first pressure relief hole is provided on a tube wall of the central tube below the action member, and when the action member moves to a position below the first pressure relief hole, an escape channel for the gas generated by a combustion of the gas generation agent is formed to pressurize the liquid fire extinguishing agent in the cannister unit.

10. The electrically-started non-pressurized-storage-type liquid-based explosion suppression cannister according to claim 9, wherein
a plurality of rows of evenly distributed second pressure relief holes are provided on the sidewalls of the combustion chamber, and the second pressure relief holes are configured to allow a portion of gas generated by the combustion of the gas generation agent to escape between the central tube and the action member, and when the action member moves to a position below the first pressure relief hole, they pressurize the liquid fire extinguishing agent in the cannister unit.

11. The electrically-started non-pressurized-storage-type liquid-based explosion suppression cannister according to claim 6, wherein the action member comprises a piston, a piston sealing ring, an anti-vibration spring, a jet tube, a bursting disc pressure cap, and a side bursting disc;
the side bursting disc, the bursting disc pressure cap the piston and the anti-vibration spring are sequentially provided below the combustion chamber in the central tube, and the jet tube is connected to a bottom of the central tube;
the side bursting disc is provided on a sidewall of the central tube, and an opening pressure thereof is greater than that of the primary rupture sheet; and
the piston is of an H-shaped structure, and two sides thereof are sealed and connected to an inside of the central tube.

12. The electrically-started non-pressurized-storage-type liquid-based explosion suppression cannister according to claim 11, wherein the side bursting disc is a positive arched bursting disc with a groove, and the groove is a cross-shaped groove with an opening pressure of 1-10 MPa.

13. The electrically-started non-pressurized-storage-type liquid-based explosion suppression cannister according to claim 2, wherein the primary rupture sheet is a positive arched bursting disc with a groove, wherein the groove is a cross-shaped groove, a diameter thereof is at least 40 mm, and the opening pressure of the primary rupture sheet is 0.2-2 MPa.

14. The electrically-started non-pressurized-storage-type liquid-based explosion suppression cannister according to claim 1, wherein:
the electrically-started non-pressurized-storage-type liquid-based explosion suppression cannister further comprises a fixed base, wherein the fixed base is configured to secure the cannister unit, and comprises a U-shaped bolt, a flange nut and a base support; and
the U-shaped bolt is secured to the base support via the flange nut, and an arc shape of the base support and the U-shaped bolt form a ring shape consistent with a shape of a top, a middle or a bottom of the cannister unit, so as to surround and secure the top, the bottom or the middle of the cannister unit; and
a conical surface is provided in the sputter nozzle to atomize and spray the fire extinguishing agent.

15. The electrically-started non-pressurized-storage-type liquid-based explosion suppression cannister according to claim 5, wherein
the gas generation agent comprises a binder, a curing agent, an oxidizing agent, and a cooling agent;
the binder comprises hydroxyl-terminated polybutadiene and/or carboxyl-terminated polybutadiene, with a content of 10% to 40% by mass;
the curing agent is toluene diisocyanate and/or isophorone diisocyanate, with a content of 0.5% to 5% by mass;
the oxidizing agent is ammonium perchlorate and/or ammonium nitrate, with a content of 20% to 60% by mass; and
the cooling agent is azodicarbonamide, with a content of 20% to 60% by mass.

16. The electrically-started non-pressurized-storage-type liquid-based explosion suppression cannister according to claim 8, wherein a first pressure relief hole is provided on a tube wall of the central tube below the action member, and when the action member moves to a position below the first pressure relief hole, an escape channel for the gas generated by a combustion of the gas generation agent is formed to pressurize the liquid fire extinguishing agent in the cannister unit.
